(19) United States
(12) Patent Application Publication
(10) Pub. No.: US 2016/0328304 A1
(43) Pub. Date: Nov. 10, 2016

(54) METHOD OF COPYING A DATA IMAGE FROM A SOURCE TO A TARGET STORAGE DEVICE IN A FAULT TOLERANT COMPUTER SYSTEM

(71) Applicants: STEPHEN J. WARK, SHREWSBURY, MA (US); ANGEL L. PAGAN, HOLDEN, MA (US)

(72) Inventors: STEPHEN J. WARK, SHREWSBURY, MA (US); ANGEL L. PAGAN, HOLDEN, MA (US)

(21) Appl. No.: 15/145,958

(22) Filed: May 4, 2016

Related U.S. Application Data
(60) Provisional application No. 62/157,840, filed on May 6, 2015.

(51) Int. Cl. G06F 11/20; G06F 11/16; G06F 9/455

(52) U.S. Cl. CPC G06F 11/2017; G06F 9/45558; G06F 11/1666; G06F 2009/45583

(57) ABSTRACT

A fault tolerant computer system is connected over a network with one or more I/O devices. The fault-tolerant computer system has two host devices each of which support a virtual machine (VM) that operates on the same set of instructions (FT application) at substantially the same time, and each VM is allocated space on different virtual containers. In the event that the operational state of one VM is downgraded, due to the unexpected failure of a virtual container associated with it, a mirroring operation is initiated that does not copy empty blocks of information from a source virtual container to a virtual container associated with the downgraded VM if corresponding blocks on the source and the target virtual containers have do not contain any information.

### 1. FIELD OF THE INVENTION

This invention relates to disk minoring techniques in a fault tolerant computer system.

### 2. BACKGROUND

Fault tolerant computer systems can be configured to simultaneously run the same application (FT application) on two different host devices. In this configuration, both host devices operate on the same set of instructions (i.e., application) at substantially the same time to generate the same results. Such a fault tolerant computer system is described in U.S. Pat. No. 8,812,907 and assigned to Marathon Technologies Corporation. The resulting data generated by the two applications running on the separate hosts can either be stored locally in separate (master/slave) memory or disk space (physical or logical), or it can be stored at a remote location in separate mass storage devices such as disks or virtual containers. Generally, each host device is allocated up to some maximum amount of space in a virtual container in which to store application data. However, during normal operation a host device typically only utilizes a fraction of the maximum amount of storage allocated to it.

In the event that the operational state of one of the host devices in a fault tolerant computer system is downgraded, the application it is supporting may stop running, and the data images stored in the two separate physical of logical locations can begin to diverge. Prior to the time that the previously downgraded host device state is upgraded to be active and online, and in order to restart the application it is supporting, it is necessary for the data images at the two separate locations to be the same. A data image associated with one host that is the same as the data image of another host is considered to be a mirror image of the other host data image.

If the operational state of one host in a fault tolerant computer system gracefully transitions from an active, online state to be offline, then it may be necessary to copy only the data from the virtual container, associated with the still active, online host, that has not been stored on the mirrored disk having divergent data associated with the slave host. This procedure is described in U.S. Pat. No. 6,728,892 and assigned to Marathon Technologies Corporation. However, in the event that the operational state downgrade of one host device is not graceful (not anticipated due to a catastrophic event at associated I/O device, such as a virtual storage container), it is possible that the data image maintained on the associated virtual container is divergent from the virtual container image associated with the active, online host. In the event that a storage device undergoes such a catastrophic failure, any disk writes that are queued and waiting to be completed are typically lost. To compound this problem, if the fault tolerant host devices are storing application data in a virtual storage environment, it is probable that neither of the host devices have sufficient visibility into the protocols used to control disk I/O operations (there are just too many layers of network control between the host devices and the physical storage devices), and so have no way of determining which writes are completed or not. Further, if a physical storage device that is used to support a virtual container fails catastrophically, then there is simply no way for the associated host to know that any of the data stored in that virtual container can be recovered. Other events that can precipitate a data image mirroring operation are, at the time a protected virtual machine (VM) is created, at the time a container fails, at the time a host fails, or at the time an I/O controller fails on a host device.

In the event that a virtual container experiences such a failure, it may be necessary to copy all of the data from a master/source storage device to a slave/target storage device in what is typically referred to as a disk mirroring operation.

### 3. BRIEF DESCRIPTION OF THE DRAWINGS

FIG. 1 is a diagram showing a fault tolerant computer system 100.

FIG. 2 is a diagram showing functional blocks comprising two host devices comprising the system 100.

FIG. 3 is a diagram illustrating logic comprising a source host device that operates to control one aspect of a mirroring process.

FIG. 4 is a diagram illustrating logic comprising a target host device that operates to control another aspect of the mirroring process.

### 4. DETAILED DESCRIPTION

Typically, during the process of creating a mirror image of a source virtual container to a target virtual container, the active, online host device employs information in a special data structure (metadata . . . configuration of virtual storage allocated to a host device) to systematically issue read requests to each location or block in a virtual container that is allocated to it, and the protocol controlling the operation of the virtual container responds to the read request by sending the data that is stored in each location to the requesting host. It is usually the case that most of the storage (blocks) that are allocated to a virtual machine running on a host device have never been written with information. In a sparse file system, such empty blocks typically have a small amount of information (metadata) that identifies them as empty blocks or invalid blocks. An unfortunate consequence of performing a mirroring procedure is that the information stored in all of the invalid blocks (metadata) on the source virtual container is read and converted into or filled with zeros, which are then copied as valid blocks on the target container. This type of mirroring operation results in an inefficient use of virtual container storage space, and as a consequence, it is not possible for the otherwise unused blocks to be provisioned to another host for use.

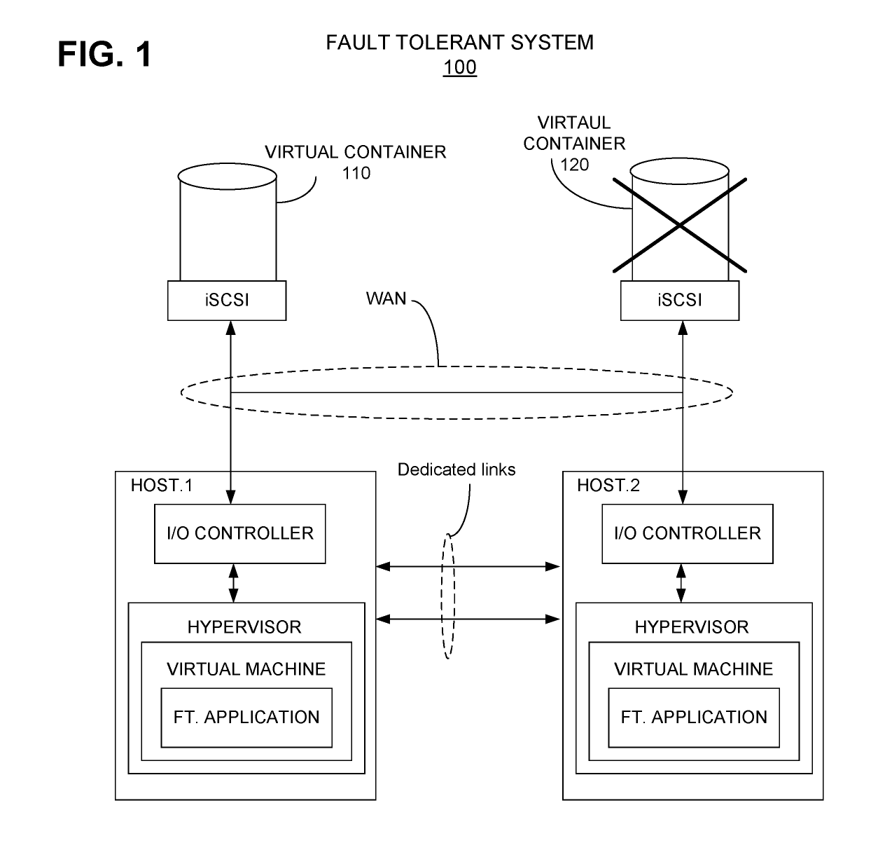

We discovered that, subsequent to a catastrophic failure of a virtual container associated with a fault tolerant system, it is not necessary to copy all of the blocks from the still functioning virtual container to the previously failed virtual container. Accordingly, a block of information identified as having only a plurality of zeros that is stored on the still functioning virtual container is not copied to the previously failed virtual container if the corresponding block on the previously failed virtual container also has only a plurality of zeros. In one embodiment, if a virtual container mirroring operation is initiated as the result of one host device of a pair of host devices operating in a fault tolerant system being unexpectedly downgraded, then the host device that remains active and on-line (source host device) can be controlled to incrementally read the contents of each location (block) in a virtual container that is allocated to it. If the source (active and on-online) host device determines that any particular block is filled with zeros, it notifies the then off-line host device (target host device) that this block is only filled with zeros, and if the target host device determines during a disk mirroring operation that the corresponding block in a virtual container allocated to it is also only filled with zeros, then the block is not copied from the source to the target virtual container. More specifically, each host device in the fault tolerant system can support the operation of one or more virtual machines. Each of a virtual machine running on a first host device and a virtual machine running on a second host device can operate together to support the same fault tolerant application. In the event that the operational state of one virtual machine is unexpectedly downgraded so that it is no longer able to support the fault tolerant application, then the still active and on-line virtual machine can be controlled to incrementally read the contents of each block of a virtual container allocated to it. At substantially the same time, the downgraded and off-line virtual machine can be controlled to read the contents of each block of a virtual container allocated to it to determine whether each block only has zeros or not. If the active and on-line virtual machine determines that a block it reads has only zeros, it can send an indication to the off-line virtual machine that this block has only zeros, and if the off-line virtual machine determines that a block it read, corresponding to the block read by the active and on-line virtual machine, is also has only zeros, then the invalid block read by the active and on-line virtual machine is not copied to the target virtual container. A fault tolerant computer system 100 in which each one of two or more host devices control the operation of at least one virtual machine to run a fault tolerant application is described below with reference to FIG. 1.

FIG. 1 shows a fault tolerant computer 100 having two host devices, Host.1 and Host.2, each one of which operates to support the same fault tolerant (FT) application. Each host device, Host.1 and Host.2, is in communication with the other host device over a set of dedicated links, and each host device is allocated and in communication over a network (WAN) with a different virtual container, container 110 and container 120 respectively. Each host device has an I/O controller and a hypervisor that operates to manage the operation of one or more virtual machines running on the host device, and each virtual machine can control the operation of an instance of a fault tolerant (FT) application. Each FT application comprises a set of instructions that when operated on by the virtual machine can result in the generation of information to be written to a virtual container, or it can result in the virtual machine generating a request to read information stored in the virtual container. During normal, fault tolerant operation, the hypervisor in each of the hosts operate on each instruction in the set of instructions at substantially the same time, and to generate the same I/O requests to the associated virtual containers (or other I/O devices) at substantially the same time.

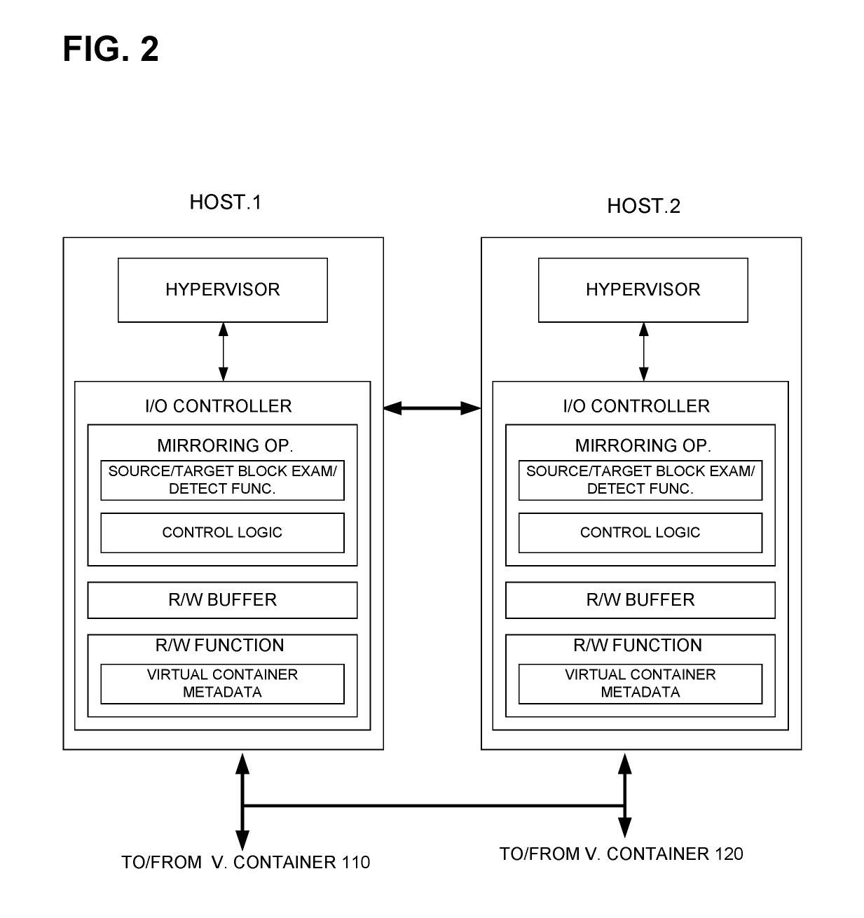

In the event that an I/O device, that is essential to the fault tolerant operation of the system 100, stops operating without warning, it is likely that write requests buffered in a virtual container controller (iSCSI for instance) will not be completed and the information associated with each write request that is not completed is lost. For example, if in FIG. 1 the virtual container 120 becomes unavailable to a virtual machine running on the Host.2 without warning, then any outstanding write requests queued at the iSCSI will not be completed, and the FT application information associated with the write requests will be lost. Regardless, the virtual machine running on the Host.1 continues to support the application (albeit not an FT application at this point) during the time that the problem with the virtual container 120 is corrected, and as a consequence, the container 110 and 120 images diverge. At the point in time that the virtual machine running on the Host.2 determines that the virtual container 120 is operational, it can signal to the virtual machine running on Host.1 to initiate an incremental or full disk mirroring operation. Typically, in the event of an unexpected failure in a virtual container, a full mirroring operation is performed. A more detailed description of the functionality comprising Host.1 and Host.2 is undertaken below with reference to FIG. 2.

FIG. 2 shows functionality comprising Host.1 and Host.2, described earlier with reference to FIG. 1, with each host being connected over a network to virtual container space, virtual containers 110 and 120, allocated to them. In addition to each host device having a hypervisor, or some other functionality that operates to manage one or more virtual machines running on each host device, FIG. 2 shows that each I/O controller has a disk mirroring routine or operation, it has an I/O read/write (R/W) buffer of some sort, and it has read/write (R/W) functionality. The R/W functionality operates on instructions sent to it by the hypervisor to generate and send read/write requests to the virtual containers, and to receive information from a virtual container in response to a read request or a message from the virtual container confirming that a write operation has been completed. In the event that the I/O controller receives information or data as the result of a read request to one or more blocks maintained on the virtual container, it can store these blocks of information in the R/W buffer until needed by the FT application running in the hypervisor, or until needed by the mirroring operation. The R/W functionality also maintains metadata which is information relating to the structure of the virtual container space allocated to it (virtual container mapping table). This metadata can be accessed by the I/O controller when generating an I/O request.

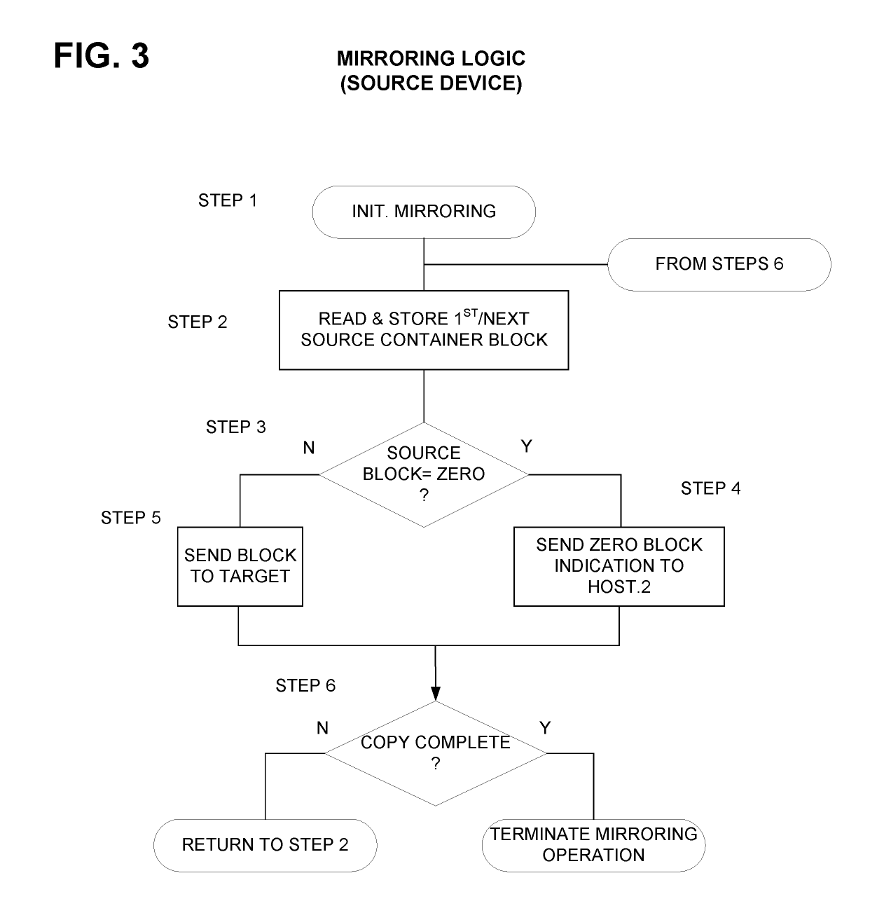

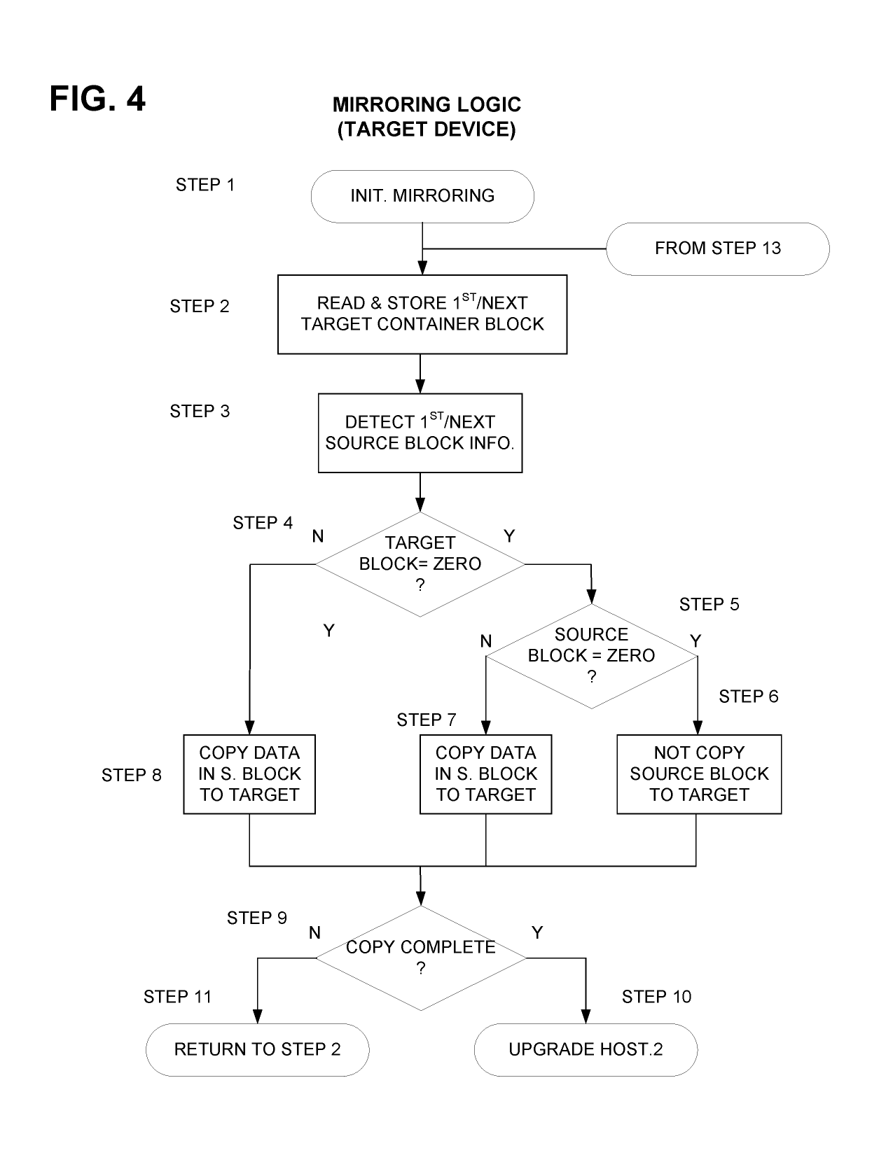

Continuing to refer to FIG. 2, the mirroring operation comprising the I/O controller has logical instructions that can control a virtual container mirroring procedure. While the procedure described here is a full disk mirroring operation, the I/O controller has logic that controls an incremental mirroring operation as well. In one embodiment, this logic controls a full mirroring operation to not copy blocks of information stored in a source virtual container having only zeros to a target virtual container, provided a corresponding block in the target container is also only has zeros stored. By only copying non-zero blocks from one virtual container to another during a mirroring operation, a sparse file system can be maintained, and so container space that might not otherwise be available for use by another virtual machine, is preserved and available. In addition to the control logic, the mirroring operation has functionality that operates to examine the contents of each block of information read from either the source or target virtual container. This functionality operates to detect whether a block is filled with valid data, or if the block is empty/all zeros (has metadata representative of an empty block). When an empty block is read, the virtual container I/O controller converts metadata stored at the empty block into a valid block filled with zeros. Copying blocks with all zeros from the source to the target container needlessly expands the storage space used by a virtual machine, and so it is not desirable to copy these blocks. In the event that a virtual container which is allocated to a VM running on Host.2 becomes unavailable without warning, the operational state of that VM can be downgraded, and the application it is running is no longer available. At some point subsequent to the VM being downgraded, the original virtual container allocated to it (or some other virtual container space) can become available, and as described below with reference to FIGS. 3 and 4, a virtual container mirroring procedure can be initiated that does not copy empty blocks of information from the source virtual container 110 to the target virtual container 120 if the corresponding target block is also has only zeros.

The following description assumes that the virtual machine running on the Host.1 is active and on-line, and that the VM running on the Host.2 device is active, and off-line due to an unexpected failure of the virtual container 120. Accordingly, the logic in FIG. 3 operates on the Host.1 device and the logic in FIG. 4 operates on the Host.2 device.

In Step 1 of FIG. 3, the mirroring procedure is initiated. This procedure can be initiated by the either VM sending an instruction to the other VM to start reading blocks from a source virtual container, or the message can have an instruction that commands the VM running on Host.1 mirroring operation to start a full container to container copy. Regardless, in Step 2 the logic controls the R/W function to issue a read request to a first block in the virtual container 110. Information stored in the first block read is returned to the VM running on Host.1 and temporarily stored in the R/W buffer comprising the Host.1 I/O controller. Then in Step 3, the information in this block is examined by the examination and detection function to identify what type of information is stored in the block, and if it is determined that the entire block is filled with zeros (indicating that the data may not be valid), in Step 4 the Host.1 I/O controller (mirroring op.) generates and sends a message to the mirroring operation running on the VM in Host.2 with an indication that the first block read is filled with zeros. On the other hand, if in Step 3 the logic determines that the first block read has valid data, then in Step 5 the data in this block is sent to the target virtual machine running in Host.2. If in Step 6 it is determined that the mirroring procedure is not complete, then the process returns to Step 2, and continues on this loop until all of the valid blocks in virtual container 110 have been copied to virtual container 120. If in Step 6 it is determined that all of the information stored in valid blocks on virtual container 110 have been copied to virtual container 120, then the mirroring procedure it terminated on Host.1. While the mirroring logic in FIG. 3 is described as controlling the procedure to read one block at a time, the logic can control the procedure to read multiple blocks from the virtual container allocated to it at the same time. The embodiment described herein is not limited by the number of blocks read at any particular time.

As described above with reference to FIG. 3, the mirroring operation running in the Host.1 can either send an indication that a particular block is filled with zeros, or it can send the entire contents stored in a valid block to the mirroring operation running on the Host.2. Regardless, after the mirroring procedure in the Host.2 is initiated in Step 1 of FIG. 4, the I/O controller in Step 2 is instructed to start reading blocks stored in virtual container 120. The I/O controller can be instructed to only read one block and then wait until the Host.2 mirroring operation receives block information from the Host.1, or it can be instructed to continuously issue read requests to virtual container 120 until all of the blocks in the container are read. Continuously reading target blocks can decrease the amount of time needed to perform the mirroring procedure. One objective is to hide the cost of scanning a block for zeros. On the source/master side, the zero scan is balanced by not having to send a block of zeros to the target/slave. On the target/slave side, we are hiding the read and zero scan behind the time it takes the source/ master to read and scan. The information read in each block is stored at least temporarily in the R/W buffer comprising the I/O controller in the Host.2. In Step 3, if the function detects that a first block of information is received from the VM running on Host.1, then in Step 4 the logic determines (using the source/target block examination function) whether the block read in Step 2 is filled with zeros or not. If in Step 4 it is determined that the first target block read is filled with zeros, then the mirroring procedure continues to Step 5 where the logic determines whether the source block detected in Step 3 is filled with zeros or not. If in Step 5 the source block detected in Step 3 is filled with zeros, then the information in the source block (all zeroes) is not copied to the target block. But if in Step 5 the block detected in Step 3 has valid non-zero data, then the procedure continues to Step 7 and the information in the source block is copied to the target virtual container.

Continuing to refer to FIG. 4, if in Step 4 it is determined that the block read in Step 2 (first target block) has non-zero data, then the procedure continues to Step 8 and the information in the source block is copied to the target block. Continuing to Step 9, if a determination is made that all of the blocks that need to be copied from the source to the target virtual container have been copied, then the procedure continues to Step 10, and the state of the VM running on the Host.2 can be upgraded, otherwise the procedure can return to Step 2 and continue in this program loop until the mirroring procedure is completed.

We claim:

1. A method of performing a disk mirroring operation between a source virtual storage container and a target virtual storage container in a fault tolerant computer system, comprising:
reading, by a first virtual machine comprising the fault tolerant computer system, a first block of information in the source virtual container and determining that the first block of information is only filled with a plurality of zeros;
reading, by a second virtual machine comprising the fault tolerant computer system, a block of information in the target virtual container that corresponds to the first block of information read by the first virtual machine in the source virtual container, and the second virtual machine determining that the block of information it reads is only filled with a plurality of zeros; and
controlling the fault tolerant computer system to not copy the first block of information read from the source virtual container to the target virtual container.

2. The method of claim 1, further comprising the fault tolerant computer system detecting that the operational state of the target virtual container is downgraded prior to initiating the disk mirroring operation.

3. The method of claim 1, wherein the first virtual machine is running on a first host device comprising the fault tolerant computer system and the second virtual machine is running on a second host device comprising the fault tolerant computer system.

4. The method of claim 3, wherein the current operational state of the first host device is active and on-line, and the current operational state of the second host device is off-line or downgraded.

5. The method of claim 1, wherein the first and the second virtual machines operate together to support a fault tolerant application, and the fault tolerant application running on each of the first and second virtual machines is the same.

6. The method of claim 1, wherein the current state of the source virtual storage container is operational and the current state of the target virtual container is unexpectedly downgraded.

7. The method of claim 6, wherein the current state of the target virtual container is unexpectedly downgraded due to a catastrophic failure.

8. A method of maintaining a sparse virtual container file in a fault tolerant computer system, comprising:
initiating, by the fault tolerant computer system, a disk mirroring operation between a source virtual container and a target virtual container in which a first virtual machine reads a block of information stored on the source virtual container and a second virtual machine reads a block of information stored on the target virtual container, the first and the second virtual machines and the source and target virtual containers comprising the fault tolerant computer system;
the first and second virtual machines determining that the block of virtual container information each reads is only filled with a plurality of zeros, and preventing the block of information being copied from the source to the target virtual container.

9. The method of claim 8, further comprising the fault tolerant computer system detecting that the operational state of the target virtual container is downgraded prior to initiating the disk mirroring operation.

10. The method of claim 8, wherein the first virtual machine is running on a first host device comprising the fault tolerant computer system and the second virtual machine is running on a second host device comprising the fault tolerant computer system.

11. The method of claim 10, wherein the current operational state of the first host device is active and on-line, and the current operational state of the second host device is off-line or downgraded.

12. The method of claim 8, wherein the first and the second virtual machines operate together to support a fault tolerant application, and the fault tolerant application running on each of the first and second virtual machines is the same.

13. The method of claim 8, wherein the current state of the source virtual storage container is currently operational and the current state of the target virtual container is unexpectedly downgraded.

14. The method of claim 13, wherein the current operational state of the target virtual container is unexpectedly downgraded due to a catastrophic failure.

15. A fault tolerant computer system, comprising:
a first virtual machine running on a first host device having read and write access to blocks of information stored on a source virtual container, and a second virtual machine running on a second host device having read and write access to blocks of information stored on a target virtual container, and both the first and second virtual machines operating to support a fault tolerant computer application that is the same, and the fault tolerant computer system operates to initiate a disk mirroring operation subsequent to detecting an unexpected downgrade in the operational state of the target virtual container, whereby a block of information read by the first virtual machine from the source virtual container only having zeros is not copied to the target virtual machine if a corresponding block of information read by the second virtual machine from the target virtual container also only has zeros.
